(19) United States
(12) Patent Application Publication
(10) Pub. No.: US 2021/0357586 A1
(43) Pub. Date: Nov. 18, 2021

(54) Reinforcement Learning Approach to Modify Sentences Using State Groups

(71) Applicant: Covid Cough, Inc., Greenwood Village, CO (US)

(72) Inventor: Michelle Archuleta, Lakewood, CO (US)

(21) Appl. No.: 17/273,600

(22) PCT Filed: Sep. 4, 2019
(86) PCT No.: PCT/US2019/049609

§ 371 Date: Mar. 4, 2021

Related U.S. Application Data
(60) Provisional application No. 62/726,532, filed on Sep. 4, 2018.

(51) Int. Cl. G06F 40/253; G06F 40/30; G06N 3/08; G06F 40/166; G06F 40/205

(52) U.S. Cl. CPC G06F 40/253; G06F 40/30; G06F 40/205; G06F 40/166; G06N 3/084

(57) ABSTRACT

Methods, systems, and apparatus, including computer programs language encoded on a computer storage medium for a language modification system whereby input jargon language is modified to plain language using a reinforcement learning system with a real-time reward grammar engine. The actions of an agent are limited by three different methods: an operational window that defines the grammatical boundary or states that an agent can perform actions within an environment, state groups that specify that actions must be performed to all states belonging to a state group, and the length of the environment or input sentence. The reinforcement learning agent learns a policy of edits and modifications to a sentence such that the output sentence is grammatical and retains the intended meaning.

### RELATED APPLICATIONS

This application claims priority to U.S. Provisional Patent Application No. 62/726,532 entitled “Reinforcement learning approach to modify sentences using word groups.” Filed Sep. 4, 2018, the entirety of which is hereby incorporated by reference.

### TECHNICAL FIELD

The present invention relates generally to Artificial Intelligence related to reinforcement learning for grammatical correction. In particular, the present invention is directed to natural language processing and reinforcement learning for simplifying jargon into layman terms and is related to classical approaches in natural language processing such as formal language theory, grammars, and parse trees. In particular, it relates to generalizable reward-mechanisms for reinforcement learning such that the reward mechanism is a property of the environment.

### BACKGROUND ART

There are approximately 877,000 (AAMC The Physicians Foundation 2018 Physician Survey 2018) practicing doctors in the United States. The average number of patients seen per day in 2018 was 20.2 (Id. at pg. 22). The average amount of time doctors spend with patients has decreased to 20 minutes per patient (Christ G. et al. The doctor will see you now—but often not for long 2017). In this limited amount of time physicians are unable to properly explain complex medical conditions, medications, prognosis, diagnosis, and plans for self-care.

Patients' experience of healthcare in the form or written and oral communication is most often incomprehensible due to jargon filled language. Personalized information such as health records, genetics, insurance, etc. while most valuable and pertinent is completely inaccessible to most individuals.

The ability to simplify jargon into plain understandable language can have significant benefits for, e.g., patients. For example, in a medical application, layman language can save lives because a patient that understands their condition, their medication, their prognosis, or their diagnoses will be more likely to be compliant and/or identify medical staff errors.

Manually substituting plain language for medical jargon and rearranging the words such that the sentence makes sense would be a substantial cost to develop for use, e.g., in the healthcare system when healthcare and insurance companies are cutting back. The cost of having doctors simplify EHRs would be unwieldy.

An estimate: 877,000 (total active doctors)×20.2 (patients seen per day)×7.5 (additional minutes for simplifying an EHR note)/1440 (minutes in a day)˜92,268 additional 24-hr days for the medical workforce per day of seeing patients. The average overall physician salary is $299,000 a year or $143/hour (Kane L, Medscape Physician Compensation Report 2018). Simplifying EHR would result in an additional total cost per year for the entire healthcare system of $4.8B.

The unmet need is to simplify medical jargon into plain language. The unmet need would only be accomplished with a language modification system that consists of hardware devices (e.g. desktop, laptop, servers, tablet, mobile phones, etc.), storage devices (e.g. hard drive disk, floppy disk, compact disk (CD), secure digital card, solid state drive, cloud storage, etc.), delivery devices (paper, electronic display), a computer program or plurality of computer programs, and a processor or plurality of processors. A language modification system when executed on a processor (e.g. CPU, GPU) would be able to transform language into plain language such that the final output would be reviewed by an expert and delivered to end users through a delivery device (paper, electronic display).

There are no solutions in the prior art that could fulfill the unmet need of simplifying medical jargon language such as EHRs, insurance, genetics, etc. The prior art is limited by software programs that require human input and human decision points, supervised machine learning algorithms that require massive amounts (10⁹-10¹⁰) of human generated paired labeled training datasets, algorithms that are unable to rearrange words within a sentence to make the sentence understandable and grammatical, algorithms that are brittle and unable to perform well on datasets that were not present during training.

### DISCLOSURE OF THE INVENTION

This specification describes a language modification system that includes a reinforcement learning system and a real-time grammar engine implemented as computer programs one or more computers in one or more locations. The language modification system components include input data, computer hardware, computer software, and output data that can be viewed by a hardware display media or paper. A hardware display media may include a hardware display screen on a device (computer, tablet, mobile phone), projector, and other types of display media.

Generally, the system performs targeted edits on a sentence using a reinforcement learning system such that an agent learns a policy to perform the fewest amount of edits that result in a grammatical sentence. An environment that is the input sentence, an agent, a state (e.g. word, character, or punctuation), an action (e.g. deletion, insertion, substitution, rearrangement, capitalization, or lowercasing), and a reward (positive—grammatical sentence, negative—non-grammatical sentence) are the components of a reinforcement learning system. The reinforcement learning system is coupled to a real-time grammar engine such that each edit (action) made by an agent to the sentence results in a positive reward if the sentence is grammatical or a negative reward if the sentence is non-grammatical. To improve performance a reinforcement learning system is constrained in the following ways: 1) edits performed by an agent are only performed in a specific location within a sentence, an operation window, 2) edits performed by an agent must be performed on all states (e.g. words) that belong to a particular group or state group.

In general, one or more innovative aspects may be embodied in an operation window. An operational window is used to constrain an agent to only perform actions at a location within a sentence whereby a sentence is not grammatical. A reinforcement learning agent is learning a policy to optimize total future reward such that actions performed result in a grammatical sentence. A grammatical sentence is defined by the productions of grammar and the subset of part-of-speech tags for all word(s), character(s), and/or punctuation(s) that belong to the sentence. The combination of part-of-speech tags and grammar productions may not be adequate to result in a unique solution that retains the intended meaning of the sentence. An agent may find action(s) performed on the entire sentence that result in a grammatical sentence and thus the agent receives a reward despite the final state of the sentence being nonsensical. In order to overcome this limitation an operational window is defined such that the agent is constrained to only perform actions at a location within the sentence such that the sentence is no longer grammatical. The operational window is the first phrase in a sentence such that before the phrase the sentence is grammatical and after the phrase the sentence is no longer grammatical. The phrase of a sentence can include any grammatical phrase in a language (e.g. noun phrase, prepositional phrase, verb phrase). An agent performing actions within the operational window of the sentence is able to learn a policy such that actions taken result in a grammatical and logical sentence.

Another constraint on the search space of the reinforcement learning agent is sentence length whereby a cutoff criteria is established by an arbitrary chosen sentence length. An agent performing actions on a long sentence is likely to optimize a policy producing grammatical but nonsensical sentences. The sentence length cutoff criteria can be used to disregard sentences that exceed the sentence length value threshold.

The sentence length criteria and operational window constrain the location at which the reinforcement learning agent can perform actions. In essence, the reinforcement learning system is analogous to a surgeon's scalpel and care is taken to only apply it in a specific location.

In general, one or more innovative aspects may be embodied in a state group. A state group is a predefined membership of states such as words, characters, and/or punctuation. Types of state groups (or word groups) may include word definitions, part-of-speech phrases, co-occurring words, semantic relationships among words, or user defined groups. Semantic relationships are associations between the meanings of words or between the meanings of phrases. A state group constrains a reinforcement learning agent to perform an action on all states (words, characters, and/or punctuation) that belong to a predefined group. An example would be the state group ‘heart attack’ an agent would be required to perform actions on the words ‘heart attack’ and not the individual words ‘heart’ or ‘attack’. The advantages of using state groups is that a reinforcement learning agent learns a policy whereby the meaning and context of state groups are preserved while performing edits (actions) that result in a grammatical sentence.

In general, one or more innovative aspects may be embodied in a generalizable reward mechanism, a real-time grammar engine. A real-time grammar engine when provided with an input sentence, data sources (e.g. grammar, training data), computer hardware including a memory and a processor(s), and a computer program or computer programs when executed by a processor, outputs one of two values that specifies whether a particular sentence is grammatical or non-grammatical.

A generalizable reward mechanism is able to correctly characterize and specify intrinsic properties of any newly encountered environment. The environment of the reinforcement learning system is a sentence. An intrinsic property of a sentence is grammaticality, such that a sentence is or is not well formed in accordance with the productive rules of the grammar of a language. The measure of well formed is such that a sentence complies to the formation rules of a logical system (e.g. grammar).

The intrinsic property of grammaticality is applicable to any newly encountered sentence. In addition, grammaticality is the optimal principal objective for the language modification system defined in this specification.

A grammar engine builder computer program when executed on a processor or processors builds all of the components to construct a real-time grammar engine for a particular input sentence such that the real-time grammar engine can be immediately executed (‘real-time’) on a processor or processors to determine whether or not the input sentence is grammatical.

The grammar engine builder computer program when executed on a processor or processors is provided with a grammar such that the grammar generates a production rule or a plurality of production rules, whereby the production rules describe all possible strings in a given formal language.

The grammar engine builder computer program takes the input sentence and calls another computer program, a part-of-speech classifier, which for every word, character, and/or punctuation the part-of-speech classifier outputs a part-of-speech tag. The grammar engine builder computer program creates a grammar production rule or plurality of grammar production rules by generating the grammar rules that define the part-of-speech tags from the input sentence. The grammar engine builder computer program creates an end-terminal node production rule or plurality of end-terminal node production rules by mapping the part-of-speech tags and the words, character, and/or punctuation in the input sentence to the production rules.

The grammar engine builder computer program is provided with a parser computer program whereby residing on a memory and executed by a processor or processors provide a procedural interpretation of the grammar with respect to the production rules of an input sentence. The parser computer program searches through the space of trees licensed by a grammar to find one that has the required sentence along its terminal branches. The parser computer program provides the output signal upon receiving the input sentence. The output signal provided by the parser in real-time when executed on a processor or processors indicates grammaticality.

The grammar engine builder computer program generates the real-time grammar engine computer program by receiving an input sentence and building a specific instance of grammar production rules that are specific to the part-of-speech tags of the input sentence. The grammar engine builder computer program stitches together the following components: 1) grammar production rule or plurality of grammar production rules, 2) end terminal node production rule or plurality of end terminal node production rules that map to the part-of-speech tags of the input sentence, 3) a grammar parser.

The real-time grammar engine receives the input sentence, and executes the essential components: grammar production rules that have been pre-built for the input sentence, a grammar, and a parser. The real-time grammar engine parses the input sentence and informs a reinforcement learning system that the edits or modifications made by an agent to a sentence result in either a grammatical or non-grammatical sentence.

In some implementations a grammar can be defined as a generative grammar, regular grammar, context free grammar, context-sensitive grammar, or a transformative grammar.

Some of the advantages include a methodology that 1) allows sentences to be evaluated to determine if they are grammatical or not; 2) ungrammatical sentences are corrected using a reinforcement learning algorithm; 3) the neural network implemented in the reinforcement learning algorithm is trained with unparalleled training data derived from extensive language model word embeddings; 4) the action state space is constrained based on state groups, making a solution feasible and efficient; 5) state groups preserve the logical and contextual information of the sentence.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates a language modification system.

FIG. 2 depicts a reinforcement learning system.

FIG. 3 depicts a reinforcement learning system with example actions.

FIG. 4 illustrates a reinforcement learning system with detailed components of the grammar engine.

FIG. 5 depicts a flow diagram for reinforcement learning system with transferrable weights.

FIG. 6 shows an operation window and one or more state group in a sentence.

DRAWINGS - - - REFERENCE NUMERALS

| | | | |
|---|---|---|---|
| 100 | Language Modification | 101 | Input Jargon |
| | System | | Language |
| 102 | Hardware | 103 | Computer |
| 104 | Memory | 105 | Processor |
| 106 | Network Controller | 107 | Network |
| 108 | Data Sources | 109 | Software |
| 110 | Reinforcement | 111 | Agent |
| | Learning System | | |
| 112 | Action | 113 | Environment |
| 114 | Grammar Engine | 115 | Reward |
| 116 | Output Plain Language | 117 | Display Screen |
| 118 | Paper | | |
| 200 | Receive a sentence | 201 | New Sentence |
| 202 | Pool of states (sentence, | 203 | Function Approximator |
| | action, reward) | | |
| 204 | Return grammatically | | |
| | correct sentence | | |
| 300 | Example actions on | | |
| | state groups | | |
| 400 | Grammar | 401 | Grammar Productions |
| 402 | POS classifier | 403 | POS tags |
| 404 | End terminal productions | 405 | Produce Computer Program |
| 406 | Execute Computer Program | 407 | Parse Sentence |
| 500 | Save weights | 501 | Load weights |
| 600 | Non-grammatical sentence | 601 | Operational window |
| 602 | Start | 603 | End |
| 604. | State Group | 605 | Grammatical sentence |

### BEST MODE OF CARRYING OUT THE INVENTION

### Language Modification System

Simplifying sentences by substituting plain language terms for specialty jargon can make a sentence nonsensical. This can affect the readability, intention, and grammar of the sentence. The same need for clarity can be true for machine translation in which words need to be reordered within the sentence in order to maintain the same meaning.

Take for example the sentence, ‘He was treated with a intravenous fluid bolus with subsequent improvement.’ To simplify the sentence with plain language definitions, the sentence could be changed to: ‘He was treated with a given into the vein large amount of fluid with subsequent improvement.’ This sentence is no longer grammatically correct, makes no sense, and confuses the intent and meaning of the sentence despite the substitution of plain language terms. If instead the sentence read ‘He was treated with a large amount of fluid given into the vein with subsequent improvement.’ the original objective of simplifying the sentence would have been met. This sentence has both plain language terms and word rearrangements which makes the sentence easy to read and grammatical.

In order to achieve a software program that is able, either fully or partially, to simplify jargon laden sentence into plain language by processing, e.g., electronic health records (EHRs), that program may transform the records into lay person friendly language. Another goal of the invention is to rearrange words within a sentence so that the grammar and semantics are preserved. Another challenge is that such a program must be able to scale and process large datasets.

Embodiments of the invention are directed to a language modification system whereby a corpus of jargon filled language is provided by an individual or individuals(s) or system into a computer hardware whereby data sources and the input corpus are stored on a storage medium and then the data sources and input corpus are used as input to a computer program or computer programs which when executed by a processor or processor provides as output plain language which is provided to an individual or individual(s) on a display screen or printed paper.

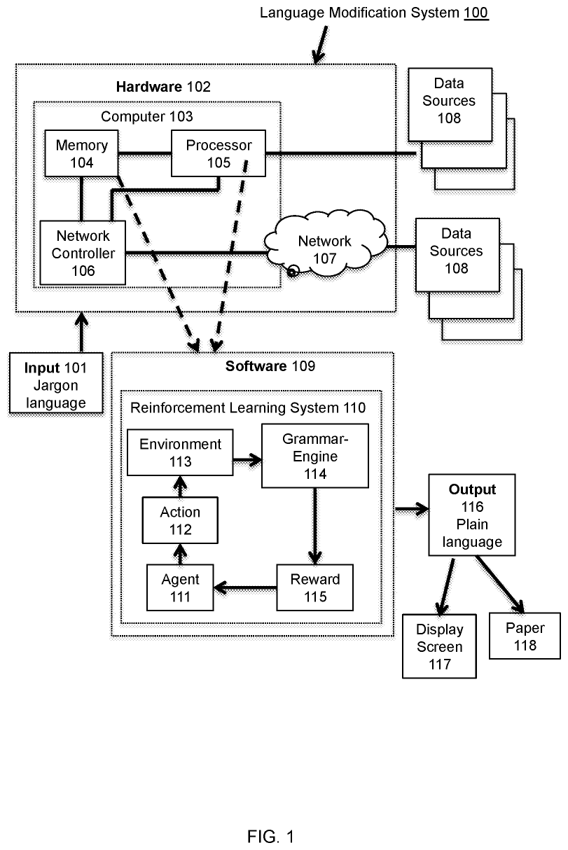

FIG. 1 illustrates a language modification system 100 with the following components: input 101, hardware 102, software 108, and output 116. The input is jargon language such as an language in a EHR, a medical journal, a prescription, a genetic test, and an insurance document, among others. The input 101 may be provided by an individual, individuals or a system and entered into a hardware device 102 such as a computer 103 with a memory 104, processor 105 and or network controller 106. A hardware device is able to access data sources 108 via internal storage or through the network controller 106, which connects to a network 107.

The data sources 108 that are retrieved by a hardware device 102 in one of other possible embodiments includes for example but not limited to: 1) a corpus of medical terms mapped to plain language definitions, 2) a corpus of medical abbreviations and corresponding medical terms, 3) an English grammar that incorporates all grammatical rules in the English language, 4) a corpus of co-occurrence medical words, 5) a corpus of co-occurring words, 6) a corpus of word-embeddings, 7) a corpus of part-of-speech tags.

The data sources 108 and the jargon language input 101 are stored in memory or a memory unit 103 and passed to a software 109 such as computer program or computer programs that executes the instruction set on a processor 105. The software 109 being a computer program executes a reinforcement learning system 110 on a processor 105 such that an agent 111 performs actions 112 on an environment 113, which calls a reinforcement learning reward mechanism, a grammar engine 114, which provides a reward 115 to the system. The reinforcement learning system 110 makes edits to the sentence while ensuring that the edits result in a grammatical sentence. The output 116 from the system is plain language that can be viewed by a reader on a display screen 117 or printed on paper 118.

In one or more embodiments of the language modification system 100 hardware 102 includes the computer 103 connected to the network 107. The computer 103 is configured with one or more processors 105, a memory or memory unit 104, and one or more network controllers 106. It can be understood that the components of the computer 103 are configured and connected in such a way as to be operational so that an operating system and application programs may reside in a memory or memory unit 104 and may be executed by the processor or processors 105 and data may be transmitted or received via the network controller 106 according to instructions executed by the processor or processor(s) 105. In one embodiment, a data source 108 may be connected directly to the computer 103 and accessible to the processor 105, for example in the case of an imaging sensor, telemetry sensor, or the like. In one embodiment, a data source 108 may be executed by the processor or processor(s) 105 and data may be transmitted or received via the network controller 106 according to instructions executed by the processor or processors 105. In one embodiment, a data source 108 may be connected to the reinforcement learning system 110 remotely via the network 107, for example in the case of media data obtained from the Internet. The configuration of the computer 103 may be that the one or more processors 105, memory 104, or network controllers 106 may physically reside on multiple physical components within the computer 103 or may be integrated into fewer physical components within the computer 103, without departing from the scope of the invention. In one embodiment, a plurality of computers 103 may be configured to execute some or all of the steps listed herein, such that the cumulative steps executed by the plurality of computers are in accordance with the invention.

A physical interface is provided for embodiments described in this specification and includes computer hardware and display hardware (e.g. a printer used for delivering a printed plain language output). Those skilled in the art will appreciate that components described herein include computer hardware and/or executable software which is stored on a computer-readable medium for execution on appropriate computing hardware. The terms “computer-readable medium” or “machine readable medium” should be taken to include a single medium or multiple media that store one or more sets of instructions. The terms “computer-readable medium” or “machine readable medium” shall also be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random Access Memory (RAM), and/or Erasable Programmable Read-Only Memory (EPROM). The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. In other embodiments, some of these operations might be performed by specific hardware components that contain hardwired logic. Those operations might alternatively be performed by any combination of programmable computer components and fixed hardware circuit components.

In one or more embodiments of the language modification system 100 software 109 includes the reinforcement learning system 110 which will be described in detail in the following section.

In one or more embodiments of the language modification system 100 the output 116 includes layman friendly language. An example would be layman friendly health records which would included: 1) modified grammatical simplified sentences, 2) original sentences that could not be simplified or edited but are tagged for visual representation. The output 116 of layman friendly language will be delivered to an end user via a display medium such as but not limited to a display screen 117 (e.g. tablet, mobile phone, computer screen) and/or paper 118.

Additional embodiments may be used to further the experience of a user such as the case of health records. An intermediate step may be added to language modification system 100 such that the plain language 116 is output in a display screen 117 that can then be reviewed by an expert, edited by an expert, and addition comments from the expert saved with the plain language 116. An example is a simplified health record that is reviewed by a doctor. The doctor also is able edit a sentence and provides a comment with further clarification for a patient. The doctor is then able to save edits and comments and then submit the plain language 116 health record to her patient's electronic health portal. The patient would received the plain language 116 health record and view it on the display screen of his tablet after logging into his patient portal.

### Reinforcement Learning System

Further embodiments are directed to a reinforcement learning system that performs actions within an operational window of the sentence such that actions are performed on state groups (e.g. word groups) whereby, a real-time grammar-engine reward mechanism returns a reward that is dependent on the grammaticality of the sentence. The embodiment of a reinforcement learning system with a real-time grammar-engine reward mechanism enables actions such as but not limited to reordering word phrases within a sentence to make the sentence understandable.

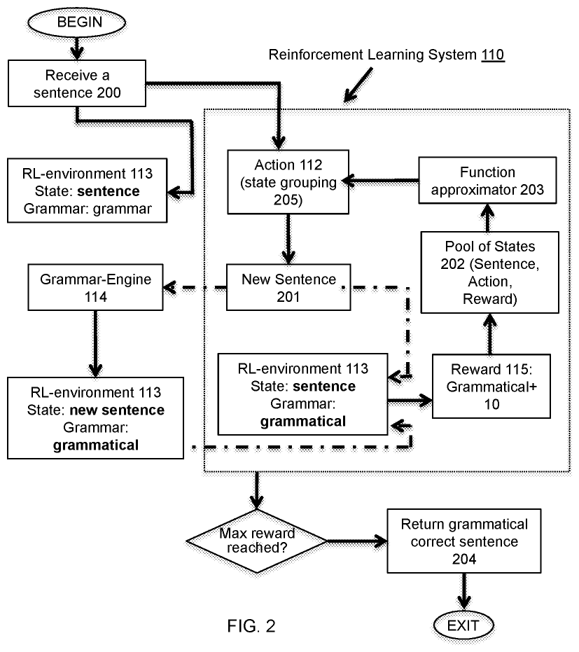

A reinforcement learning system 110 with grammar-engine reward mechanism is defined by an input 101, hardware 102, software 108, and output 116. FIG. 2. Illustrates an in 0.787401put to the reinforcement learning system 110 that may include but is not limited to a sentence 200 that is preprocessed and either modified or unmodified by another computer program or computer programs from the input jargon language 101. Another input includes data sources 108 that are provide to the grammar engine 113 and function approximator 203 and will be described in the following sections.

The reinforcement learning system 110 uses a hardware 102, which consists of a memory or memory unit 104, and processor 105 such that software 109, a computer program or computer programs is executed on a processor 105 and performs edits to the sentence resulting in a grammatical plain language sentence 204. The output from reinforcement learning system 110 in an embodiment is combined in the same order as the original jargon language such that the original language is reconstructed to produce plain language output 116. A user is able to view the plain language output 116 on a display screen 117 or printed paper 118.

FIG. 2 depicts a reinforcement learning system 110 with an input sentence 200 and an environment that holds state information consisting of the sentence, and the grammaticality of the sentence 113; such that an agent performs actions 112 on a state group 205; and a grammar engine 114 is used as the reward mechanism returning a positive reward 115 if the sentence is grammatical and a negative reward if the sentence is non-grammatical 115. An agent receiving the sentence is able to perform actions 112 (e.g. deletion, insertion, substitution, rearrangement, capitalization, or lowercasing) on the sentence resulting in a new sentence 201. The new sentence 201 is updated in the environment and then passed to a grammar engine 114 which updates the environment with a that specifies a grammar state (True-grammatical sentence, False-non-grammatical sentence). The grammar engine 114 also returns a reward 115 to the reinforcement-learning environment such that a change resulting in a grammatical sentence results in a positive reward and a change resulting in a non-grammatical sentence results in a negative reward.

A pool of states 202 saves the state (e.g. sentence), action (e.g. deletion), reward (e.g. positive). After exploration and generating a large pool of states 202 a function approximator 203 is used to predict an action that will result in the greatest total reward. The reinforcement learning system 110 is thus learning a policy to perform edits to a sentence resulting in grammatically correct sentences. One or more embodiments specify termination once a maximum reward is reached and returns a grammatically correct sentence 204. Additional embodiments may have alternative termination criteria such as termination upon executing a certain number of iterations among others. Also for given input sentences 200 it may not be possible to produce a grammatically correct sentence 204 in such instances the original sentence could be returned and highlighted such that an end user could differentiate between simplified sentence and original jargon language.

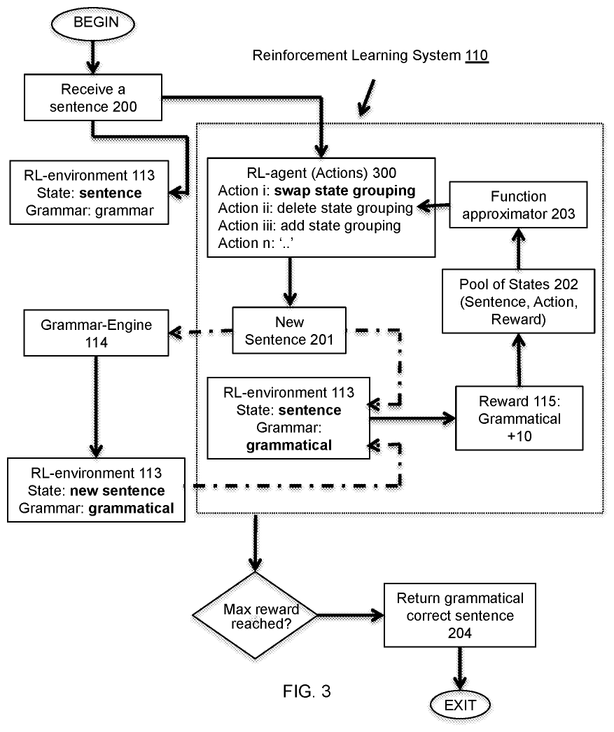

FIG. 3. Illustrates examples of actions 300 that are performed by an agent 111 to state groups 205 within the sentence. State groups 205 may include but not limited to members of a definition, subcategory of a parse tree, or co-occurring words, or a semantic representation of words. An action 300 is performed on all states belonging to a predefined group, the state group. The constraint of actions taken only to state groups allows for modifications to be made to a sentence while maintaining the meaning and context of a particular sentence.

For example, if the agent in the reinforcement learning system were to reorder the word ‘heart’ which is located next to the word ‘attack’ and a predefined state group was ‘heart attack’, the agent would have to move the word phrase ‘heart attack’ instead of just reordering the word ‘heart’. In the example of ‘heart attack’ the meaning is preserved for the disease condition and not reorder to the body part ‘heart’. In an instance in which a word does not belong to a state group the agent can perform actions on the word itself.

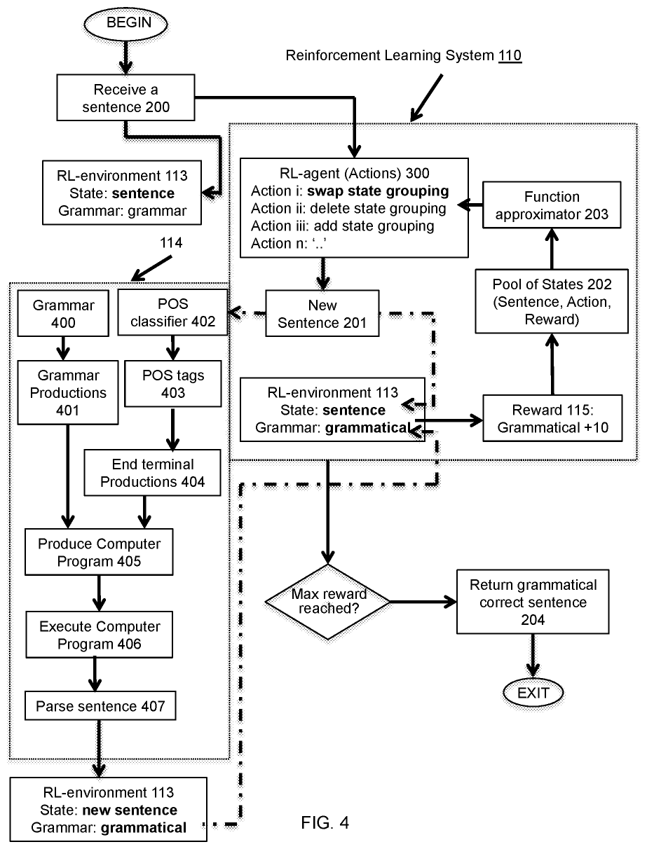

FIG. 4 illustrates a reinforcement learning system 110 with detailed components of the grammar engine 114. A grammar 400 is defined and used as an input data source 104 such that grammatical productions 401 are produced for the input sentence. A part-of-speech (POS) classifier 402 is used to determine the part-of-speech for each word, character, or punctuation in the sentence such that a POS tag 403 is returned. The POS tags 403 are then used to produce end terminal productions 404 for the corresponding grammar 400 that relates to the input sentence 201. The final grammar productions 401 and a parser are written to a computer program 405. The computer program stored in memory 104 receives a new sentence 201 and executes on a processor 405 such that the input sentence is parsed. The output of the grammar engine 114 is both an executable computer program 406 and the value that specifies whether the sentence was grammatical or non-grammatical. A corresponding positive reward 115 is given for a grammatical sentence and a negative reward 115 is given for a non-grammatical sentence.

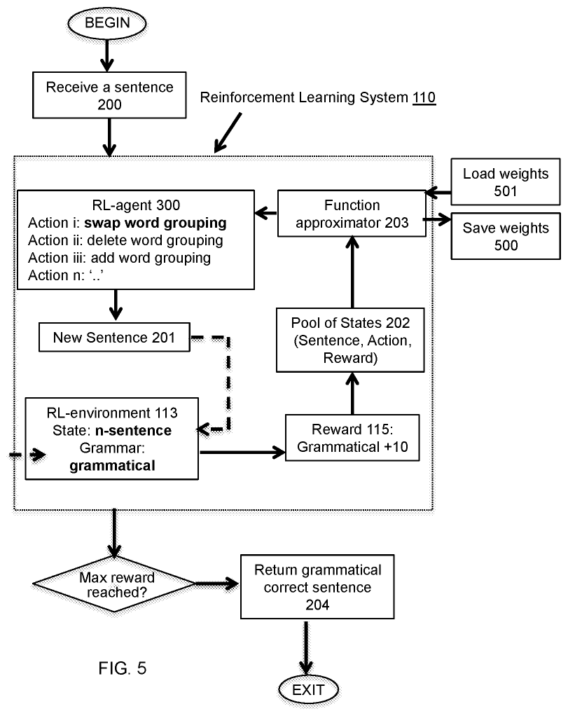

FIG. 5 illustrates a reinforcement learning system 110 with transferrable learning mechanism. The transferrable learning mechanism is weights from a function approximator (e.g. convolutional neural network CNN) that has optimized a learning policy whereby a minimal number of edits that result in a grammatical sentence have been learned. The weights from a function approximator can be stored in a memory 104 such that the weights are saved 500. The weights can be retrieved by a reinforcement learning system 110 and loaded into a function approximator 501. The transferrable learning mechanism enables the optimal policy from a reinforcement learning system 110 to be transferred to a naive reinforcement learning system 110 such that the system 110 will have a reduction in the amount of time required to learn the optimized policy.

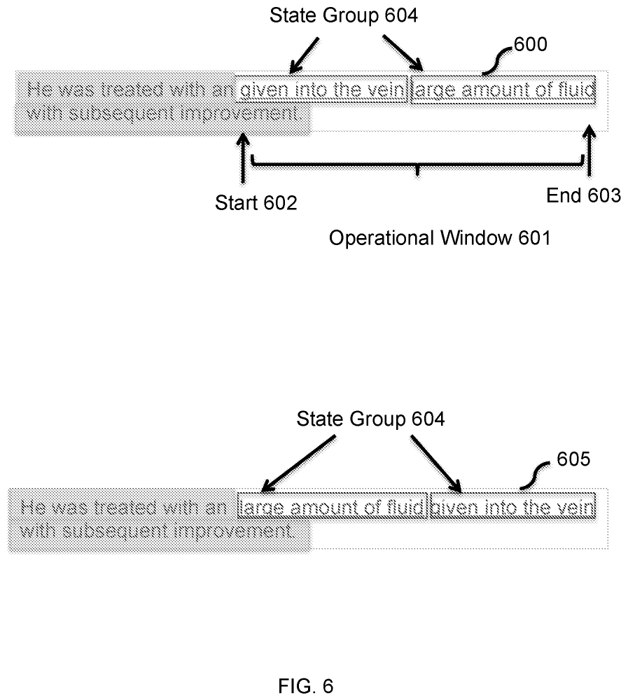

FIG. 6 illustrates an example sentence 600 with an operational window 601 with a start 602 and an end 603 location such that within operational window 601 the sentence is non-grammatical. In addition state groups 604 are found within the sentence. The state groups 604 shown in this example are word groups such that a medical word ‘intravenously’ is substituted for a plain language definition ‘given into the vein’ and ‘bolus’ is substituted for a plain language definition ‘large amount of fluid.’ The state groups 604 are predefined and constrain an agent 111 to perform actions on all words, characters, and/or punctuation belonging to that state group 604. An agent 111 is allowed to perform actions constrained by the operational window 601 and only all members of a state group 604 resulting in a grammatically correct sentence. The advantage of one or more embodiments is that the reinforcement learning system is only applied in constrained locations and taking into account the context of the sentence by confining actions to state groups 604.

### Operation of Reinforcement Learning System

One of the embodiments provides a grammar engine such that a sentence can be evaluated in real-time and a set of actions performed on a sentence that does not parse in order to restore the grammatical structure of the sentence. In this embodiment a sentence and thus its attributes (e.g. grammar) represents the environment. An agent can interact with a sentence and receive a reward such that the environment and agent represent a Markov Decision Process (MDP). The MDP is a discrete time stochastic process such that at each time step the MDP represents some state s, (e.g. word, character, number, and/or punctuation) and the agent may choose any action a that is available in state s. The action is constrained to include all members belonging to a state group. The process responds at the next time step by randomly moving all members of a state group into a new state s′2 and passing new state s′2 residing in memory to a real-time grammar engine that when executed on a processor returns a corresponding reward Rₐ (s,s2) for s′2.

The benefits of this and other embodiments include the ability to evaluate and correct a sentence in real-time. This embodiment has application in many areas of natural language processing in which a sentence maybe modified and then evaluated for its structural integrity. These applications may include sentence simplification, machine translation, sentence generation, and text summarization among others. These and other benefits of one or more aspects will become apparent from consideration of the ensuing description.

One of the embodiments provides an agent with a set of words within a sentence or a complete sentence and attributes of which include a model and actions, which can be taken by the agent. The agent is initialized with number of features per word, 128, which is the standard recommendation. The agent is initialized with max words per sentence 20, which is used as an upper limit to constrain the search space. The agent is initialized with a starting index within the input sentence. The starting index may be the pointer that would define an operational window for performing actions to only a segment of words within a sentence or it may be set to zero for performing actions to all words within the sentences.

The agent is initialized with a set of hyperparameters, which includes epsilon ε (ε=1), epsilon decay, ε_decay (ε_decay=0.999), gamma, γ (γ=0.99), and a loss rate η (η=0.001). The hyperparmeter epsilon ε is used to encourage the agent to explore random actions. The hyperparmeter epsilon ε, specifies an ε-greedy policy whereby both greedy actions with an estimated greatest action value and non-greedy actions with an unknown action value are sampled. When a selected random number, r is less than epsilon ε, a random action a is selected. After each episode epsilon ε is decayed by a factor ε_decay. As the time progresses epsilon ε, becomes less and as a result fewer non-greedy actions are sampled.

The hyperparmeter gamma, γ is the discount factor per future reward. The objective of an agent is to find and exploit (control) an optimal action-value function that provides the greatest return of total reward. The standard assumption is that future rewards should be discounted by a factor γ per time step.

The final parameter the loss rate, η is used to reduce the learning rate over time for the stochastic gradient descent optimizer. The stochastic gradient descent optimizer is used to train the convolutional neural network through back propagation. The benefits of the loss rate are to increase performance and reduce training time. Using a loss rate, large changes are made at the beginning of the training procedure when larger learning rate values are used and decreasing the learning rate such that a smaller rate and smaller training updates are made to weights later in the training procedure.

The model is used as a function approximator to estimate the action-value function, q-value. A convolutional neural network is the best mode of use. However, any other model maybe substituted with the convolutional neural network (CNN), (e.g. recurrent neural network (RNN), logistic regression model, etc.).

Non-linear function approximators, such as neural networks with weight θ make up a Q-network which can be trained by minimizing a sequence of loss functions, Lᵢ(θᵢ) that change at each iteration i,

Lᵢ(θᵢ)=E_{s,a˜p(·)}[(yᵢ−Q(s,a;θ)²)

where yᵢ=E_{s,a˜p(·);ś˜ξ}┌(r+ [symbol] (śá; Θᵢ₋₁)|s, a)┌ is the target for iteration i and ρ(s, a) is a probability distribution over states s or in this embodiment sentences s. and actions a such that it represents a sentence-action distribution. The parameters from the previous iteration θᵢ are held fixed when optimizing the loss function, Lᵢ(θᵢ). Unlike the fixed targets used in supervised learning, the targets of a neural network depend on the network weights. Taking the derivative of the loss function with respect to the weights yields,

$${∇}_{{Θ}_{i}} {L}_{i} ( {Θ}_{i} ) = {E}_{s , a ∼ ρ ( \cdot ) ; {s}^{{′}^{′}} ∼ ξ} ⌈ ( r + γ {max}_{{a}^{{′}^{′}}} Q ( {s}^{′} {a}^{′} ; {Θ}_{i - 1} ) - Q ( s , a ; {Θ}_{i} ) ) {∇}_{{Θ}_{i}} Q ( s , a ; {Θ}_{i} ) ⌉$$

It is computationally prohibitive to compute the full expectation in the above gradient; instead it is best to optimize the loss function by stochastic gradient descent. The Q-learning algorithm is implemented with the weights being updated after an episode, and the expectations are replaced by single samples from the sentence-action distribution, ρ(s, a) and the emulator ξ.

The algorithm is model-free which means that is does not construct an estimate of the emulator ξ but rather solves the reinforcement-learning task directly using samples from the emulator ξ. It is also off-policy meaning that it follows ε-greedy policy which ensures adequate exploration of the state space while learning about the greedy policy a=maxₐQ(s, a; θ).

A CNN was configured with a convolutional layer equal to the product of the number of features per word and the maximum words per sentence, a filter of 2, and a kernel size of 2. The filters specify the dimensionality of the output space. The kernel size specifies the length of the 1D convolutional window. One-dimensional max pooling with a pool size of 2 was used for the max-pooling layer of the CNN. The model used the piecewise Huber loss function and adaptive learning rate optimizer, RMSprop with the loss rate, η hyperparameter.

After the model is initialized as an attribute of the agent, a set of actions are defined that could be taken for each word within an operational window in the sentence. The model is off-policy such that it randomly selects an action when the random number, r [0,1] is less than hyperparmeter epsilon ε. It selects the optimal policy and returns the argmax of the q-value when the random number, r [0,1] is greater than the hyperparmeter epsilon ε. After each episode epsilon ε is decayed by a factor ε_decay, a module is defined to decay epsilon ε. Finally, a module is defined to take a vector of word embeddings and fit a model to the word embeddings using a target value.

One of the embodiments provides a way in which to map a sentence to its word-embedding vector. Word embedding comes from language modeling in which feature learning techniques map words to vectors of real numbers. Word embedding allows words with similar meaning to have similar representation in a lower dimensional space. Converting words to word embeddings is a necessary pre-processing step in order to apply machine learning algorithms which will be described in the accompanying drawings and descriptions. A language model is used to train a large language corpus of text in order to generate word embeddings.

Approaches to generate word embeddings include frequency-based embeddings and prediction based embeddings. Popular approaches for prediction-based embeddings are the CBOW (Continuous Bag of Words) and skip-gram model which are part of the word2vec gensim python packages. The CBOW in the word2vec python package on the Wikipedia language corpus was used.

A sentence is mapped to its word-embedding vector. First a large language corpus (e.g. English Wikipedia 20180601) is trained on the word2vec language model to generate corresponding word embeddings for each word. Word embeddings were loaded into memory with a corresponding dictionary that maps words to word embeddings. The number of features per word was set equal to 128 which is the recommended standard. A numeric representation of a sentence was initialized by generating a range of indices from 0 to the product of the number of features per word and the max words per sentence. Finally a vector of word embeddings for an input sentence is returned to the user.

One of the embodiments provides an environment with a current state, which is the current sentence that may or may not have been modified by the agent. The environment is also provided with the POS-tagged current sentence and a reset state that restores the sentence to its original version before the agent performed actions. The environment is initialized with a maximum number of words per sentence.

One of the embodiments provides a reward module that returns a negative reward r− if the sentence length is equal to zero; it returns a positive reward r+ if a grammar built from the sentence is able to parse the sentence; and returns a negative reward r− if a grammar built from the sentence is unable to parse the sentence.

At operation, a sentence is provided as input to a reinforcement-learning algorithm a grammar is generated in real-time from the sentence. The sentence and grammar represents an environment. An agent is allowed to interact with the sentence and receive the reward. In the present embodiment, at operation the agent is incentivized to perform actions to the sentence that result in a grammatically correct sentences.

First a min size, batch size, number of episodes, and number of operations are initialized in the algorithm. The algorithm then iterates over each episode from the total number of episodes; for each episode e, the sentence s, is reset from the environment reset module to the original sentence that was the input to the algorithm. The algorithm then iterates over k total number of operations; for each operation the sentence s is passed to the agent module act. A number, r is randomly selected between 0 and 1, such that if r is less than epsilon e, the total number of actions, nₜₒₜₐₗ is defined such that nₜₒₜₐₗ=nₐ^{W}^{ₛ} where nₐ is the number of actions and wₛ is the words in sentence s. An action a, is randomly selected between a range of 0 and nₜₒₜₐₗ and the action a, is returned from the agent module act.

After an action a, is returned it is passed to the environment. Based on the action a, a vector of subactions or a binary list of 0s and 1s for the length of the sentence s is generated. After selecting subactions for each word in a sentence s the agent generates a new sentence s2 from executing each subaction on each word in sentence s. The subactions are constrained to include state groups such that an action must be performed on all states belonging to a group.

The binary list of 0s and 1s may include the action of deleting words if the indexed word has a ‘1’ or keeping words if the indexed word has a ‘0’. The sentence s2 is then returned and passed to the reward module.

A grammar is generated for the sentence s2 creating a computer program for which the sentence s2 is evaluated. If the grammar parses the sentence a positive reward r+ is returned otherwise a negative reward r− is returned. If k, which is iterating through the number of operations is less than the total number of operations a flag terminate is set to False otherwise set flag terminate to True. For each iteration k, append the sentence s, before action a, the reward r, the sentence s2 after action a, and the flag terminate to the tuple list pool. If k<number of operations repeat previous steps else call the agent module decay epsilon, e by the epsilon decay function e_decay.

Epsilon e is decayed by the epsilon decay function e_decay and epsilon e is returned. If the length of the list of tuples pool is less than the min size repeat steps previous steps again. Otherwise randomize a batch from the pool. Then for each index in the batch set the target=r, equal to the reward r for the batch at that index; generate the word embedding vector s2_vec for each word in sentence 2, s2 and word embedding vector s_vec for each word in sentence, s. Next make model prediction X using the word embedding vector s_vec. If the terminate flag is set to False make model prediction X₂ using the word embedding vector s2_vec. Using the model prediction X₂ compute the q-value using the Bellman equation: q−value=r+γmaxX₂ and then set the target to the q-value. If the terminate flag is set to True call agent module learn and pass s_vec and target and then fit the model to the target.

The CNN is trained with weights θ to minimize the sequence of loss functions, Lᵢ(θᵢ) either using the target as the reward or the target as the q-value derived from Bellman equation. A greedy action a, is selected when the random number r is greater than epsilon e. The word embedding vector s_vec is returned for the sentence s and the model then predicts X using the word embedding vector s_vec and sets the q-value to X. An action is then selected as the argmax of the q-value and action a returned.

Reinforcement Learning does not Require Paired Datasets.

The benefits of a reinforcement learning system 109 vs. supervised learning are that it does not require large paired training datasets (e.g. on the order of 10⁹ to 10¹⁰ (Goodfellow I. 2014)). Reinforcement learning is a type of on-policy machine learning that balances between exploration and exploitation. Exploration is testing new things that have not been tried before to see if this leads to an improvement in the total reward. Exploitation is trying things that have worked best in the past. Supervised learning approaches are purely exploitative and only learn from retrospective paired datasets.

Supervised learning is retrospective machine learning that occurs after a collective set of known outcomes is determined. The collective set of known outcomes is referred to as paired training dataset such that a set of features is mapped to a known label. The cost of acquiring paired training datasets is substantial. For example, IBM's Canadian Hansaard corpus with a size of 10⁹ cost an estimated $100 million dollars (Brown 1990).

In addition, supervised learning approaches are often brittle such that the performance degrades with datasets that were not present in the training data. The only solution is often reacquisition of paired datasets which can be as costly as acquiring the original paired datasets.

### Real-Time Grammar Engine

One or more aspects includes a real-time grammar engine, which consists of a shallow parser and a grammar, such as, but not limited to, a context free grammar, which is used to evaluate the grammar of the sentence and return a reward or a penalty to the agent. A real-time grammar engine is defined by an input (101, 201), hardware 102, software 108, and output (113 & 115). A real-time grammar engine at operation is defined with an input sentence 201 that has been modified by a reinforcement learning system 110, a software 109 or computer program that is executed on hardware 102 that includes a memory 104 and a processor 105 resulting in an output a value that specifies a grammatical sentence vs. a non-grammatical sentence. The output value updates the reinforcement learning system environment (113) and provides a reward (115) to the agent (111).

One or more aspects of a context free grammar, as defined in formal language theory, is a certain type of formal grammar such that sets of production rules describe all possible strings in a given formal language. These rules can be applied regardless of context. A formal language theory deals with the hierarchies of language families defined in a wide variety of ways and is purely concerned with the syntactical aspects rather than the semantics of words. They can also be applied in reverse to check whether a string is grammatically correct. These rules may include all grammatical rules that are specified in any given language.

One or more aspects of a parser processes input sentences according to the productions of a grammar, and builds one or more constituent structures that conform to the grammar. A parser is a procedural interpretation of the grammar. The grammar is a declarative specification of well-formedness such that when a parser evaluates a sentence against a grammar it searches through the space of trees licensed by a grammar to find one that has the required sentence along its terminal branches. If a parser fails to return a match the sentence is deemed non-grammatical and if a parser returns a match the sentence is said to be grammatical.

An advantage of a grammar engine is that it has sustained performance in new environments. An example is that the grammar engine can correct a sentence from doctor's notes and another sentence from a legal contract. The reason being that grammar engine rewards an agent based on whether or not a sentence parses. The grammaticality of the sentence is a general property of either a sentence from a doctor's note or a sentence in a legal contract. In essence in selecting a reward function, the limited constraint introduced in the aspect of the reinforcement learning grammar-engine was the design decision of selecting a reward function whose properties are general to new environments.

A reinforcement learning system updates a policy such that modifications made to a sentence are optimized to a grammatical search space. A grammatical search space is generalizable and scalable to any unknown sentence that a reinforcement learning system may encounter.

A real-time grammar engine in operation, which receives a sentence 201, and then outputs a computer program with grammar rules that when executed on a processor 105 return the grammaticality of the input sentence 201. First the input sentence 201 is parsed to generate a set of grammar rules. A parse tree is generated from the sentence; the sentence is received 201 from the reinforcement learning environment 110; each word in the sentence is tagged with a part-of-speech tag 403; a grammar rule with the start key S that defines a noun, verb, and punctuation is defined 401; a shallow parser grammar is defined, such as a grammar that chunks everything as noun phrases except for verbs and prepositional phrases; the shallow parser grammar is evaluated using a parser, such as nitk.RegexpParser; and parse the part-of-speech tagged sentence using the shallow parser.

After parsing the sentence a set of grammar rules are defined. The grammar rules start with the first rule that includes the start key S that defines a noun, verb, and punctuation; a grammar rule is initialized for each part-of-speech tag in the sentence; then for each segment in the parse tree a production is appended to the value corresponding part-of-speech keys for the grammar rules; additional atomic features for each individual grammar tags, such as singularity and plurality of nouns, are added to the grammar rules; all intermediate production are produced, such as

$$PP \to IN NP ;$$

finally, for each word in the sentence a production is created which corresponds to the words POS tag and appends a new grammar rule

$$( e . g . NNS \to dogs ) .$$

After creating a set of grammar rules and productions the grammar rules are written to a computer program stored on a memory 104, which is then used to evaluate the grammaticality of the sentence by executing the computer program on a processor 105. The computer program is executed on a processor 105; and if the sentence parses return value True otherwise value False. The value is returned to the reinforcement learning system 110 such that a positive reward 115 is returned if the sentence parse returns a True and a negative reward 115 is returned if the sentence parse returns False.

In some implementations a grammar, a set of structural rules governing the composition of clauses, phrases, and words in a natural language maybe defined as a generative grammar whereby the grammar is a system of rules that generates exactly those combinations of words that form grammatical sentences in a given language. A type of generative grammar, a context free grammar, specifies a set of production rules describe all possible strings in a given formal language. Production rules are simple replacements and all production rules are one-to-one, one-to-many, or one-to-none. These rules are applied regardless of context.

In some implementations a grammar maybe defined as a regular grammar whereby a formal grammar is right-regular or left-regular. A regular grammar has a direct one-to-one correspondence between the rules of a strictly right regular grammar and those of a nondeterministic finite automaton, such that the grammar generates exactly the language the automaton accepts. All regular grammars generate exactly all regular languages.

In some implementations a grammar maybe defined as a context-sensitive grammar such that the syntax of natural language where it is often the case that a word may or may not be appropriate in a certain place depending on the context. In a context-sensitive grammar the left-hand sides and right-hand sides of any production rules may be surrounded by a context of terminal and nonterminal symbols.

In some implementations a grammar maybe defined as a transformative grammar (e.g. grammar transformations) such that a system of language analysis recognizes the relationship among the various elements of a sentence and among the possible sentences of a language and uses processes or rules called transformations to express these relationships. The concept of transformative grammars is based on considering each sentence in a language as having two levels of representation: a deep structure and a surface structure. The deep structure is the core semantic relations of a sentence and is an abstract representation that identified the ways a sentence can be analyzed and interpreted. The surface structure is the outward sentence. Transformative grammars involve two types of production rules: 1) phrase structure rules 2) transformational rules such rules that convert statements to questions or active to passive voice, which acted on the phrase markers to produce other grammatically correct sentences.

### Agent Performs Actions in the Operational Window

One of the embodiments provides a grammar engine that can determine the location within a non-grammatical sentence where the sentence no longer parses. One of the embodiments can build a sentence from a parse tree and determine the location before and after the sentence becomes non-grammatical. These benefits among other benefits provide an operational window in which a set of actions can be preformed to make the sentence grammatical. The embodiment narrows the window of action enabling an algorithm to take advantage of a smaller search space. The benefits of a smaller search space provide feasibility to finding an optimal sentence structure within an allotted time. These and other benefits of one or more aspects will become apparent from consideration of the ensuing description.

The reinforcement learning system with a grammar engine in which an agent is constrained to perform actions within an operational window begins by iteratively building sentences. The system mentioned above iteratively builds sentences by appending segments of the original sentences parse tree, and then evaluates the grammaticality of the newly created sentences until it reaches a location where the sentence no longer parses. The algorithm then returns two pointers, which specify the operational window 601 such that modification can be made within the operational window 601 to restore the structural integrity to the sentence.

The first process is to generate a parse tree for the sentence. The following steps detail such an approach: 1) a sentence that does not parse is received; 2) next each word in the sentence is labeled with it POS tag by evaluating the sent with a POS classifier; 3) then a grammar rule is defined with a start key S, such that the grammar rule S consists of a noun, verb, and punctuation; a shallow parser grammar is defined, such as a grammar that chunks everything as noun phrases except for verbs and prepositional phrases; 4) the shallow parser grammar is evaluated using a parser, such as nitk.RegexpParser; 5) using the parser evaluated on the shallow parser grammar production rules parse the pos-tagged sentence.

The second process is to define an operational window within the sentence by iteratively building sentences by appending a segment of the parse tree to a minimal sentence and in real-time (e.g. immediately) building a grammar from the minimal sentence. A computer program residing in memory and executed by a processor performs the following steps: 1) defines grammar production that completes the grammar rule S key with a noun and verb; 2) punctuations is added to the new minimal length sentence; 3) a grammar is built to evaluate the minimum length sentence; 4) save the minimum length sentence to a temporary variable 4) if the minimum length sentence parses continue steps 1-3 by appending to the previous minimum length sentence until the sentence no longer parsers; 5) if the minimum length sentence no longer parses the start of the operational window will be the temporary variable and the end of the operation window will be the minimum sentence length.

One of the embodiments provides state groups within an operational window. State groups or word groups are able to provide context and conserve logical constructs of a sentence while providing a mechanism for a reinforcement-learning agent to modify sentence structure. A word group is a type of state group whose members include only words. State groups (e.g. word groups) provide a logical representation for how a sentence should be dissected and manipulated which can significantly constrain the search space for a reinforcement agent trying to optimize a policy. These and other benefits of one or more aspects will become apparent from consideration of the ensuing description and accompanying drawings.

‘However, prior to the test, the patient became sweaty and sick to the stomach with a cannot be felt by hand blood pressure.’ is an example of a sentence with a grammatical error, which can be corrected by moving a noun to a position. However moving the noun results in nonsensical sentence. Using word groups and moving word phrase we are able to make a sentence both grammatical and logically correct. These and other benefits of one or more aspects will become apparent from consideration of the ensuing description and accompanying drawings.

Particular types of state groups can be obtained using data science and natural language processing techniques. Examples of state groups or word groups are top ten most frequent n-grams POS-tags, top 100 most frequent n-gram medical words (n=2-5) to be used with word groups.

### Generalizable Reward Mechanism Performs Well in New Environments.

Reinforcement learning with traditional reward mechanism does not perform well with new environments. An advantage of one or more embodiments of the reinforcement learning system described in this specification is that the real-time grammar engine reward mechanism represents a generalizable reward mechanism or generalizable reward function. A generalizable reward mechanism, generalizable function, is able to correctly characterize and specify intrinsic properties of any newly encountered environment. The environment of the reinforcement learning system is a sentence.

The intrinsic property of grammaticality is applicable to any newly encountered environment (e.g. sentence or sentences). An example of different environments is a corpus of health records vs. a corpus of legal documents. The different environments may be different linguistic characteristics of one individual writer vs. another individual writer (e.g. Emergency Room (ER) physician writes in shorthand vs. a general physician who writes in longhand).

From the description above, a number of advantages of some embodiments of the reinforcement learning grammar-engine become evident:

(a) The reinforcement learning grammar-engine is unconventional in that it represents a combination of limitations that are not well-understood, routine, or conventional activity in the field as it combines limitations from independent fields of natural language processing and reinforcement learning.

(b) The grammar engine can be considered a generalizable reward mechanism in reinforcement learning. An aspect of the grammar engine is that a grammar is defined in formal language theory such that sets of production rules or productions of a grammar describe all possible strings in a given formal language. The limitation of using a grammar defined by formal language theory enables generalization across any new environment, which is represented as a sentence in MDP.

(c) An advantage of the reinforcement learning grammar-engine is that reinforcement learning is only applied to a limited scope of the environment. An aspect of the reinforcement learning grammar engine first identifies the location in the sentence in which the sentence no longer parses. It is only at this defined location that reinforcement learning is allowed to operate on a sentence.

(d) An advantage of using state groups is that reinforcement learning is capturing the sematic relationships between words in the sentence. Take for example the word group ‘heart attack’ if reinforcement learning were allowed to swap individually the words ‘heart’ and ‘attack’ such that they no longer co-occur together within a sentence, the sentence would no longer obtain its intended meaning.

(e) An advantage of the reinforcement learning grammar-engine is that it provides significant costs savings in comparison to supervised learning either traditional machine learning or deep learning methods. The acquisition cost of paired datasets for a 1 million word multi-lingual corpus are $100 k-$250 k. The cost savings comes from applying reinforcement learning, which is not limited by the requirement of paired training data.

(f) An advantage of the reinforcement learning grammar-engine is that it scalable and can process large datasets creating significant cost savings. The calculation provided in the Background section for manually simplifying doctor's notes into patient friendly language shows that such an activity would cost the entire healthcare system $4.8B per year in USD.

(g) Several advantages of the reinforcement learning grammar-engine applied to simplifying doctors notes into patient friendly language are the following: reduction of healthcare utilization, a reduction in morbidity and mortality, a reduction in medication errors, a reduction in 30-day readmission rates, an improvement in medication adherence, an improvement in patient satisfaction, an improvement in trust between patients and doctors and additional unforeseeable benefits.

### INDUSTRIAL APPLICABILITY

A language modification system could be applied to the following use cases in the medical field:

1) A patient receives a medical pamphlet in an email from his doctor on a new medication that he will be taking. There are medical terms in the pamphlet that are unfamiliar to him The patient using a tablet could copy and paste the content of the medical pamphlet into the language modification system and hit the submit button. The simplification system would retrieve a storage medium and execute a computer program(s) on a processor(s) and return the content of the medical pamphlet simplified into plain language, which would be displayed for the patient on a display screen on his iPad.

2) A doctor enters a patient's office visit record into the EHR system and clicks on a third-party application containing the simplification system and the input patient record. The doctor then clicks the simplify button. The simplification system would retrieve a storage medium and execute a computer program(s) on a processor(s) and return the content of the patient's office visit record simplified into plain language which would be reviewed by a doctor using the display screen of her workstation. After the doctor completed her review the doctor then forwards the simplified patient note to the patient's electronic healthcare portal. The patient can view the note is his patient portal using the display screen of his Android phone.

3) A patient is diagnosed with melanoma and wants to understand the latest clinical trial for a drug that was recently suggested by her oncologist. The findings of the clinical trial were published in a peer-reviewed medical journal but she is unable to make sense of the paper. She copies the paper into the language modification system and hits the simplify button. The simplification system would retrieve a storage medium and execute a computer program(s) on a processor(s) and return the content of the peer-reviewed medical journal into plain language, which she can view, on the display of her iPad.

Other specialty fields that could benefit from a language modification system include: legal, finance, engineering, information technology, science, arts & music, and any other field that uses jargon.

1. A language modification system, comprising:
a jargon language;
a physical hardware device consisting of a memory unit and processor;
a software consisting of a computer program or computer programs;
a output plain language;
a display media;
the memory unit capable of storing the input sentence created by the physical interface on a temporary basis;
the memory unit capable of storing the data sources created by the physical interface on a temporary basis;
the memory unit capable of storing the computer program or computer programs created by the physical interface on a temporary basis;
the processor is capable of executing the computer program or computer programs;
wherein one or more processors; and
one or more programs residing on a memory and executable by the one or more processors, the one or more programs configured to:
provide the reinforcement learning system with state groups which constrains an agent to perform actions on all states that belong to a predefined state group.
find an operational window within the input sentence such that before the operational window a sentence is grammatical;
provide the reinforcement learning system and the input sentence with the operational window which constrains the agent to only perform actions within the operational window;
provide the reinforcement learning system and the input sentence with a grammar engine that returns a positive reward if an action resulted in a grammatical sentence and a negative reward if an action resulted in a non-grammatical sentence;
wherein the reinforcement learning system learns a policy of actions to modify a sentence that result in grammatical sentence.
the output sentences are recombined to produce the output plain language;
the output plain language is shown on the hardware display media;
wherein the language modification system performs edits on the jargon language and produces the output plain language.

2. A reinforcement learning system, comprising:
one or more processors; and
one or more programs residing on a memory and executable by the one or more processors, the
one or more programs configured to:
wherein the one or more programs perform actions from a set of available actions such that actions are constrained to a subset of state groups; select an action to maximize an expected future value of a reward function; and, wherein the reward function depends on: a function that can be applied to different environments, and thus the function is a generalizable function.

3. The system of claim 2, wherein a sentence length is used to constrain the actions of an agent.

4. The system of claim 2, wherein the state groups includes being part of a definition, belonging to a subcategory of a parse tree, co-occurring words, number group, date group, or a semantic representation of words;

5. The system of claim 2, wherein the grammar engine consists of a parser that processes input sentences according to the productions of a grammar, wherein the grammar is a declarative specification of well formed, and the parser executes a sentence stored in memory against a grammar stored in memory on a processor and returns the state of the sentence as grammatical or non-grammatical.

6. The system of claim 5, wherein the grammar engine is using a grammar defined in formal language theory such that sets of production rules describe all possible strings in a given formal language.

7. The system of claim 5, wherein the grammar engine can be used to describe all or a subset of rules for any language or all languages or a subset of languages or a single language.

8. The system of claim 5, wherein the grammar engine uses a context free grammar.

9. The system of claim 5, wherein the grammar engine uses a context sensitive grammar.

10. The system of claim 5, wherein the grammar engine uses a regular grammar.

11. The system of claim 5, wherein the grammar engine uses a generative grammar.

12. The system of claim 5, wherein the grammar engine uses transformative grammar such that a Deep structure is changed in some restricted way to result in a Surface Structure.

13. The system of claim 5, wherein the grammar engine is executed on a processor in real-time by first executing a part-of-speech classifier on words and punctuation belonging to the input sentence stored in memory on a processor generating part-of-speech tags stored in memory for the input sentence.

14. The system of claim 13, wherein the grammar engine is executed on a processor in real-time by creating a production or plurality of productions that map the part-of-speech tags stored in memory to grammatical rules which are defined by a selected grammar stored in memory.

15. A method for reinforcement learning system, comprising the steps of:
performing actions from a set of available actions wherein actions are constrained to a subset of state groups;
restricting actions performed by an agent to an operational window;
selecting an action to maximize an expected future value of a reward function, wherein the reward function depends on: a function that can be applied to different environments, and thus the function is a generalizable function.

16. The method of claim 15, wherein the grammar engine is using a grammar defined in formal language theory such that sets of production rules describe all possible strings in a given formal language.

17. The method of claim 15, wherein the grammar engine can be used to describe all or a subset of rules for any language or all languages or a subset of languages or a single language.

18. The method of claim 5, wherein the grammar engine uses a generative grammar.

19. A real-time grammar engine, comprising:
an input sentence;
a physical hardware device consisting of a memory unit and processor;
a software consisting of a computer program or computer programs;
an output signal that indicates that the input sentence is grammatical or the input sentence is non-grammatical;
the memory unit capable of storing the input sentence created by the physical interface on a temporary basis;
the memory unit capable of storing the data sources created by the physical interface on a temporary basis;
the memory unit capable of storing the computer program or computer programs created by the physical interface on a temporary basis;
wherein one or more processors; and
one or more programs residing on a memory and executable by the one or more processors, the one or more programs configured to:
provide a grammar such that the grammar generates a production rule or a plurality of production rules, wherein the production rules describe all possible strings in a given formal language;
provide a part of speech classifier computer program wherein one or more processors; and
one or more programs residing on a memory and
executable by the one or more programs configured to:
provide a part-of-speech tag to every word,
punctuation or character in the sentence;
create an grammar production rule or plurality of grammar production rules by generating the grammar rules that define the part-of-speech tags from the input sentence;
create an end-terminal node production rule or plurality of end-terminal node production rule by mapping the part-of-speech tags and the words, character, and/or punctuation in the input sentence to the production rules;
provide a parser computer program wherein one or more processors; and
one or more programs residing on a memory and executable by the one or more programs configured to:
provide a procedural interpretation of the grammar with respect to the production rules of an input sentence;
provide a search through the space of trees licensed by a grammar to find one that has the required sentence along its terminal branches;
provide the output signal upon receiving the input sentence
write the grammar production rule or the plurality of grammar production rules and the end terminal node production rule or the plurality of end terminal node production rules and the parser to a real-time grammar engine computer program or computer programs;
provide a real-time grammar engine computer program with the input sentence residing in memory wherein one or more processors; and
one or more programs residing on a memory and
executable by the one or more programs configured to:
provide a search through the space of trees licensed by a grammar to find one that has the required words, characters, and punctuations belonging to a sentence along its terminal branches;
such that if all words, characters, and punctuations are found a Boolean value is provided
such that if all words, characters, and punctuations are not found a different Boolean value is provided
wherein modifications made to a sentence can be evaluated to determine if the modifications result in a grammatical or non-grammatical sentence.
